(19) United States
(12) Patent Application Publication
(10) Pub. No.: US 2007/0213971 A1
(43) Pub. Date: Sep. 13, 2007

(54) Method For Operating an Output Device

(76) Inventors: Mazen Mosaed Al-Sulaim, Riyadh (SA); Baher Yahya AL-Ramady, Riyadh (SA)

Correspondence Address: Matthew K Ryan;Frommer Lawrence & Haug, 745 Fifth Avenue, New York, NY, 10151, US

(21) Appl. No.: 10/576,002

(22) PCT Filed: Oct. 17, 2003
(86) PCT No.: PCT/EP03/11550

§ 371 Date: Dec. 12, 2006

(51) Int. Cl. G06F 17/21

(52) U.S. Cl. 704/8

(57) ABSTRACT

The invention related to a method for operating an output device and for outputting text data in one of at least two languages with at least partly different character sets by utilizing only one input means for all languages comprising the following steps inputting at least one character by said input means, automatic checking of said at least one character and/or a sequence of characters by utilizing a number of predetermined rules related to the sequence of characters, automatic outputting of said character or sequence of characters with a first character set of a first language, if the sequence is allowed in said first language according to said predetermined rules, automatic outputting of said character or sequence of characters with a second character set of a second language, if the sequence is not allowed in said first language according to said predetermined rules. The invention further relates to the use of such a method in a word processing system and to a device suitable for performing such a method.

The invention relates to a method for operating an output device and for outputting text which composes of at least one word in one of at least two languages with at least partly different character sets.

In the modern world the transfer of and working with data and information has become one of the most important aspects. Although graphic and image data are taking its part in the overall information and data flow, a majority of information is presented as text and word information.

Text can be presented in many different ways, a typical output device in the modern computer world are displays in several forms and sizes as well as printers.

Text can be further input by different input means, one of the standard input means is a keyboard, used in a computer system together with a word processing program. As errors in typing and spelling of words have been considered as a major problem, it is known to provide dictionary databases, whereas further methods are known to use these dictionary databases to check the word which is input by e.g. a keyboard, whereas in cases a typed-in word can not be found in the dictionary database this word is marked or highlighted or even tried to be automatically corrected by replacing this typed-in word by another word, which can be found in the dictionary database and which is close enough to the originally typed-in and presumably mistyped word.

However globalization has also lead to the effect that certain words and phrases are incorportated into one language from another language, very frequently from the English language. Especially when a word or a phrase is imported from a foreign language and comprises characters which are different to the characters of a (first) language the word is imported in, the word has to be output, e.g. displayed or printed, by utilizing characters from a different character set. Usually only one input means, e.g. a keyboard is used, whereas either some keys or each of the keys are assigned in multiple ways, e.g. assigned to a character of a first character set of a first language and additionally also assigned to another character of a second character set of a second language, whereas the user has the possibility to select one of the assignments, e.g. by certain keystrokes. It is however also possible that e.g. a sequence of keystrokes is assigned to a certain character, as it is e.g. the case for Japanese characters. In any case the user has to indicate, in which way he wants to use the input means, which requires a manual selection of the specific character set to be used.

Frequently users are utilizing a first language, e.g. Arabic, Japanese, Chinese etc., with a character set which is completely different from e.g. the English language, so that frequently the character sets have to be changed.

There are methods known which enable the user of an input- and an output device for selecting a specific character set from a number of available character sets, e.g. Arabic character set, Japanese character set, Chinese character set, English character set etc. When a keyboard is used as input means, switching between different character sets can be enabled by e.g. striking certain key combinations, as mentioned above.

Based on the above mentioned systems, it is an object of the present invention to provide a method for operating an output device which simplifies the input steps for a user in case he wants to output a text with words using at least partly different character sets.

This object is solved by a method according to claim 1, as well as by a device according to claim 11. Claims 2 to 9 are related to specific advantageous realizations of the methods according to claim 1, claims 12 and 13 are related to specifically preferred embodiments of the device according to claim 11. The invention relates also to a use of a method according to one of the claims 1 to 9 in word processing systems.

According to the invention, a method for operating an output device and for outputting text data in one of at least two languages with at least partly different character sets by utilizing only one input means for all languages comprises steps of inputting at least one character by said input means, automatic checking of said at least one character and/or a sequence of characters by utilizing a number of predetermined rules related to the sequence of characters, automatic outputting of said character or sequence of characters with a first character set of a first language, if the sequence is allowed in said first language according to said predetermined rules, automatic outputting of said character or sequence of characters with a second character set of a second language, if the sequence is not allowed in said first language according to said predetermined rules.

By utilizing this method it is therefore possible for a user to just input the text, presumably comprising multiple words in two different languages, e.g. Arabic and English, by any input means, normally a keyboard, and by simply inputting the words by using the input-means, without manually selecting a different specific character set in case it is necessary for only e.g. a single word introduced.

If the user is e.g. inputting text data in Arabic language as first language, utilizing of course the Arabic character set for outputting the text data on a screen or by a printer, and in case he wants to introduce into this text e.g. a single word using an English character set, for example “x-ray” or e.g. the name of a European company, he will just have to type in “x-ray” or the characters of the European company without manually selecting the English character set before typing in this word and deselecting the English character set after typing in this word, in order to further input text with the Arabic character set.

According to the method the characters, or corresponding key strikes, of the typed-in characters(s) will be checked by said predetermined rules for said first language, in the above mentioned example the Arabic language. In case the sequence is allowable in the Arabic language, the word will simply be output using the corresponding Arabic character set. In case however the sequence is not allowable in the Arabic language according to said predetermined rules, the system automatically selects a second character set, in this case the (preferably pre-selected) English character set, and automatically outputs the word “x-ray” or of the European company by utilizing the correct character set without additional manual keystrokes being necessary for the user.

For the following word, being again an Arabic word, the system will automatically check with the Arabic dictionary database and, as the sequence is allowed in Arabic language according to the predetermined rules, the following words will be output by using the Arabic character set again.

This inventive method simplifies the necessary steps for the user to input text data and eliminates a number of keystrokes necessary for inputting and therefore accelerates the procedure.

It has to be mentioned at this point that the term “sequence” both covers the order of several characters, but also of only one e.g. starting character, as it is possible that according to certain predetermined rules a word in one language can not start with a certain character at all.

According to a preferred embodiment, it is possible to pre-select a first language with a first character set and (at least one) second language with a different character set. It should be mentioned at this point that the term “language” should be understood in its broadest possible sense, i.e. related to any type of text system using certain character sets, even in case this is not a “spoken language”. It could e.g. also be a non-real language, e.g. an artificial language, or another system using different characters in combination in order to create any kind of information of data.

The term “characters” shall include not only letters and numbers, but also any other signs like commas, decimal points, exclamation marks, mathematical variables, only in order to name a few of possible characters, which can be included in different character sets. It shall be mentioned also at this point that the different character sets might vary largely in volume, as e.g. the English language essentially comprises only of a very few number of letters plus additional characters, as mentioned above, whereas e.g. a character set for Japanese language comprises of thousands of so-called Kanjis.

According to a preferred embodiment, it will not only be possible to pre-select a first character set and a second character set, but also to change these pre-selections in order to adopt to specific and possibly changing applications. In general utilization however, normally only one first language with a first character set (normally the mother language of the user) and one second language with a second character set is selected (which will be often English).

According to an optional feature, the inventive method further comprises the step of automatic checking of said at least one character and/or a sequence of characters in one word by utilizing a further number of predetermined rules, related to the sequence of characters in said second language, if the sequence is not allowed in said first language instead of directly outputting the character with a character set of said second language, and thereafter automatic outputting of said character or sequence of characters with a second character set of a second language, if the sequence is allowed in said second language according to said predetermined rules or automatic outputting of said character or sequence of characters with said first character set of said first language, if the sequence is not allowed according to any of the predetermined rules related to the sequence of characters, wherein said word is additionally marked up.

This preferred method has the advantage that there will be an automatic checking also of a word and/or a character or a sequence characters according to predetermined rules of at least one second language, further in case of an erroneous utilization of an input means, e.g. mistyping when using the keyboard, it will be avoided that a misspelled word, although intended to be in said first language, would be unintendedly output with a second character set of a second language. The user of a method would therefore be in the position to correct mistyped words directly in the desired language.

Also with a method according to this further aspect, it is preferred to pre-select a first language with a first character set and to also pre-select at least one second language with a second character set and to also give a priority order to said second languages, if more than one second language is selected.

For the inventive method it is further preferred to nevertheless provide an additional manual selection possibility for the user, in order to enable user to select manually a certain language or a certain character set, in order to “overrule” the automatic selection. In case of a keyboard, it would be possible to provide this manual selection by striking a certain key or a combination of certain keys, either together or in sequence.

It will be also possible that e.g. a selection is indicated by a pull-down menu on the output device, e.g. on a screen, which can be selected by the user, for example by using a mouse of a computer system.

There is no restriction to certain input means, normally however a keyboard will be used as input means. The same is true for the output means, typical output devices are displays, printers, but also memory devices as “indirect output means”.

When utilizing the method according to the further aspect of the present invention and in case the word will be checked by rules of at least two languages, however the sequence not being allowed in any of the languages, the word will be output, as mentioned above, with a first character set of said first language, but will preferably be marked up or highlighted, in order to draw the attention of the user to a possible mis-typing. Marking or highlighting can be realized by outputting the word in different color and/or shape and/or size or by underlining this word or by any combination thereof. It would be also possible to indicate a possible mis-typing by an acoustic signal.

A very advantageous utilization of the method described above is the use in a word processing system, especially in word processing systems which are mainly or partly designed to work with languages and character sets being different from the English character set.

The invention also relates to a device suitable for performing a method as described above, comprising input means, output means, storing means for storing a number of predetermined rules for at least one language and processing means for checking an input word by utilizing, said predetermined rules. For the specific embodiments and advantages it is referred to the above mentioned description in order to avoid lengthy repetitions.

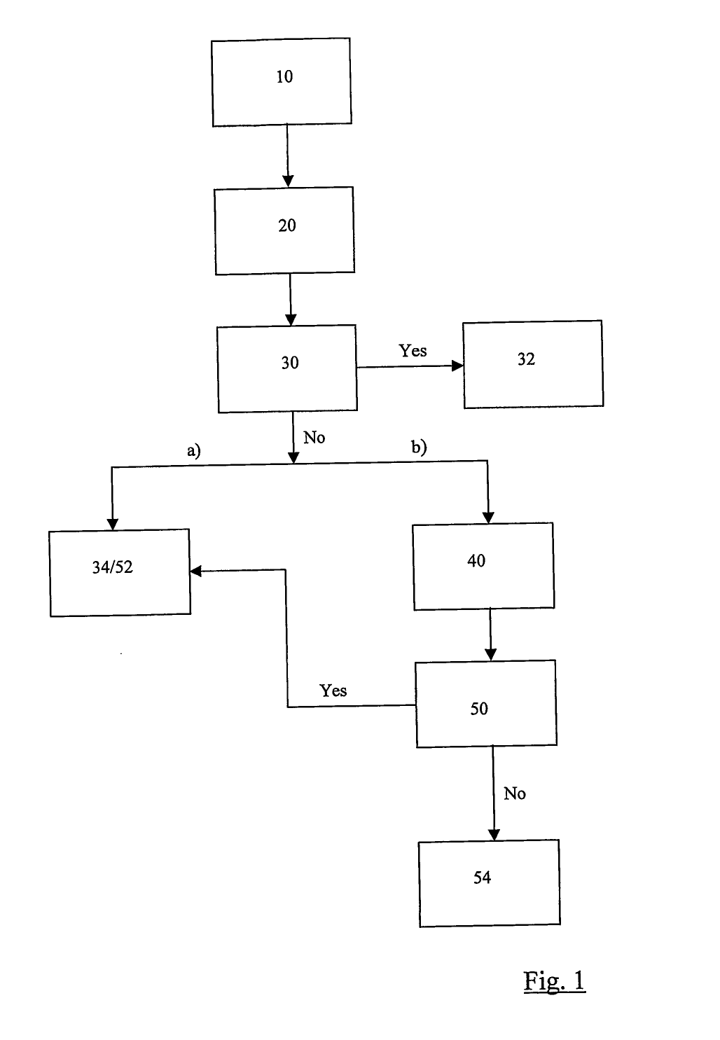

In FIG. 1 a flow diagram of a preferred embodiment showing both aspects of the invention is shown.

First a certain character or a sequence of characters is input by a user, step 10, whereas the system automatically checks said word by utilizing a number of predetermined rules for a first language, step 20, here Arabic language.

The system will then decide, whether the sequence of characters is allowed according to the predetermined rules of said first language, here Arabic, or not, step 30.

If the sequence is allowed (Yes), it will be output with said first character set of said first language, step 32.

If the sequence is not allowed (No), there are two possibilities, indicated as possibility a) and possibility b).

According to the aspect a), the character or sequence of characters will, if not allowed according to the predetermined rules of the first language, here Arabic, automatically be output with a second character set of a second language, step 34, here English

According to aspect b), the character or sequence of characters will, if not allowed according to the predetermined rules of the first language, here Arabic, again checked with a number of rules for (at least one) second language, step 40, here English, and in step 50, the system automatically decides whether the sequence is allowed in said second language.

If “Yes”, the character(s) will be output with said second character set of said second language, step 52, being in result identical to step 34, as explained above.

In case however the sequence is not allowed even according to the rules related to the second language, the character(s) will be output with a first character set of a first language, step 54, and will be, according to this preferred embodiment, additionally marked, in order to indicate for the user that presumably a mis-typing has occurred.

It shall be mentioned at this point that the aspect b) can in principal be expanded by not only adding one additional number of rules for a second language, but also a third (or further) checking step for additional languages with respective rules.

Only for completion it should be mentioned at this point that although not shown in FIG. 1, the user has, according to a preferred embodiment of the invention, always the possibility to manually select outputting character(s) of a word utilizing a specific character set for a certain language, even when overruling the automatic selection and outputting according to the inventive method, if desired

For the above mentioned and in the FIGURE described preferred embodiment, referring to the Arabic language as a first language and to the English language as a second language, the following rules regarding the languages are given as an example:

A number of predetermined rules related to the sequence of characters in a first language, here Arabic, comprises the rule that no word would start with an “z”, “x”, “m”, “n”, “Z”, “X”. If therefore the user would strike with a keyboard the letter “z”, the system would automatically recognize that this sequence, namely a word starting with “z”, is not allowed according to the rules in said first language, namely Arabic, so that automatically the system would know that the user in fact wanted to enter “z” in the English character set and not the corresponding Arabic character, which is assigned to the same key on the keyboard as “z”.

Similar regulations for the first language, Arabic, are true for the sequence of characters “in”, “im”, “on” or “ie”. If a user would strike the keys assigned to these (English) characters or the corresponding Arabic characters on the keyboard, the system would automatically recognize that the user does not intend to enter an Arabic word, as the Arabic characters, which would be input by striking the corresponding keys on the standard keyboard, are not allowed in this sequence. The system would therefore automatically output the characters or sequences of characters with the English character set.

If on the other hand a user would strike the keys, which are, beside Arabic characters, also assigned to the English characters “jj” “kk”, “ll” or “gg”, the system would, when applying the rules according to the English language, automatic recognize that this sequence is not allowed in the English language and would therefore automatically output the character using the Arabic character set or, the other way round, the system would check the predetermined rules according to the Arabic language and would automatically recognize that such a sequence is allowed in Arabic language and would output the word utilizing the Arabic character set.

It will be of course obvious to any expert that multiple further rules for each language can be determined, whereas the number of rules can be chosen freely. If more predetermined rules are utilized by the inventive method, the reliability of the method will increase. It has however to be mentioned that also a very small number of rules for a first language will lead to already a very high reliability, so that the system will work much faster and a corresponding system will need much less memory, when comparing it to checking the words by means of e.g. a dictionary database.

The features of the present invention disclosed in the specification, the claims and/or in the accompanying drawing, may, both separately and in any combination thereof, be material for realizing the invention in various forms thereof.

1-13. (canceled)

14. Method for operating an output device and for outputting text data in: one of at least two languages with a least partly different character sets by utilizing only one input means for all languages comprising the following steps:
a) Inputting at least one character by said input means;
b) Automatic checking of said at least one character and/or a sequence of characters in one word by utilizing a number of predetermined rules related to the sequence of characters;
c) Automatic outputting of said character of sequence of characters with a first character set of a first language, if the sequence is allowed in said first language according to said predetermined rules;
d) Automatic outputting of said character or sequence of characters with a second character set of second language, if the sequence is not allowed in said first language according to said predetermined rules

15. Method according to claim 14, characterized by a modified step d) comprising:
d′) Automatic checking of said at least one character and//or sequence of characters in one word by utilizing a further number of predetermined rules related to the sequence of characters in said second language, if the sequence is not allowed in said first language;
d″) Automatic outputting of said character or sequence of characters with a second character set of a second language, if the sequence is allowed in said second language according to said predetermined rule,
d′″) Automatic outputting of said character or sequence of characters with said first character set of said first language, if the sequence if not allowed according to any of the checked predetermined rules, related to the sequence of characters, wherein said character or sequence of characters is additionally marked up.

16. Method according to claim 14, providing an additional manual selection possibility for the user for outputting said character or sequence of characters in one of said character sets of the said languages.

17. Method according to claim 14, wherein said character or sequence of characters is input by a keyboard.

18. Method according to claim 14, wherein said character or sequence of characters is output by a display.

19. Method according to claim 14, wherein said character or sequence of characters is output by a printer.

20. Method according to claim 14, wherein said character or sequence of characters is output into a memory device.

21. Method according to claim 15, wherein the character or sequence or characters is marked up by being output in a different color and/or shape and/or size.

22. Method according to claim 15, wherein the character or sequence of characters is marked up by being underlined.

23. Use of a method according to claim 14 in a word processing system.

24. Devise suitable for performing a method according to claim 14, comprising:
Input means for inputting a character or a sequence of characters,
Output means for outputting a character or a sequence of characters;
Storing means for storing a number of predetermined rules, related to the sequence of characters; and
Processing means for checking of said character or sequence of characters by utilizing said predetermined rules

25. Devise according to claim 24, wherein said input means comprises a keyboard.

26. Device according to claim 24, wherein said output means comprises a display and/or a printer.
